(19) United States
(12) Patent Application Publication
(10) Pub. No.: US 2011/0320933 A1
(43) Pub. Date: Dec. 29, 2011

(54) EDITING APPARATUS, LAYOUT EDITING METHOD PERFORMED BY EDITING APPARATUS, AND STORAGE MEDIUM STORING PROGRAM

(75) Inventor: Hiroyuki Sanami, Kawasaki-shi (JP)

(73) Assignee: CANON KABUSHIKI KAISHA, Tokyo (JP)

(21) Appl. No.: 13/153,922

(22) Filed: Jun. 6, 2011

(30) Foreign Application Priority Data
Jun. 25, 2010 (JP) 2010-145524

(51) Int. Cl. G06F 17/20

(52) U.S. Cl. 715/246

(57) ABSTRACT

A region used as a reference for laying out objects selected on a page is set as a closed region within a predetermined region so as not to include an unselected object. The closed region is enlarged until it contacts on either an object that exists outside the closed region and is not selected or an edge of the predetermined region, and the enlarged closed region is determined as a layout region. A template into which the selected objects can be laid out is retrieved from multiple pre-stored templates, and the selected objects are embedded into the retrieved template.

### BACKGROUND OF THE INVENTION

1. Field of the Invention

The present invention relates to an editing apparatus for performing layout editing processing, a layout editing method, and a storage medium storing a program.

2. Description of the Related Art

Various applications running on a computer are widely used in order to design posters, catalogs, presentation data, postcards, leaflets, advertisements and so on. In general, those applications have a DTP (desktop publishing) function. Examples of the DTP function include a layout editing function of editing the layout of constituent elements for page design, such as images, characters, and clipart, and a print function of producing output to a printer.

Some of the above-described applications include a configuration for efficiently designing a page such as a pre-designed template, clipart, or a photograph in order to realize high-quality design through simple operations. Using such an application, a user can select a template that is close to his or her image of a desired design and can complete the desired design through appropriate processing such as replacing photographs, editing text, and adding decorative effects.

However, for a user who does not have enough design knowledge, it takes a long time to complete the desired design. In addition, the design completed by such a user is not always a favorable result in terms of design. The phrase “a favorable result in terms of design” as used herein refers to a design that can convey accurate contents, is easy to read, and gives a satisfactory impression. In order to achieve such a design, it is necessary to have fundamental design knowledge and know-how about layouts.

For the benefit of a user who does not have enough design knowledge, automatically performing page layout editing is conceivable. Japanese Patent Laid-Open No. 2008-146226 discloses a configuration in which an arbitrary part is selected on a page, and layout editing is automatically performed on the selected part. According to Japanese Patent Laid-Open No. 2008-146226, in the case where a user selects objects to be laid out and regions, and re-lays out the objects, variations in layout are displayed in which various types of attributes (including position adjustment) of the objects to be laid out have been changed. According to the disclosure, the user consequently only needs to select one of the variations and is thus less burdened.

However, in Japanese Patent Laid-Open No. 2008-146226, there are cases in which if a layout target region is not selected appropriately, appropriate spacing may not be provided between layout target objects and non-target objects even if the layout target objects have been laid out appropriately. One conceivable example is that an inappropriate layout result is given on a page as a whole as a result of providing inappropriate and unbalanced spacing between layout target objects and non-target objects.

### SUMMARY OF THE INVENTION

An aspect of the present invention is to eliminate the above-mentioned problems with the conventional technology. The present invention provides an editing apparatus, a layout editing method, and a program in which an object targeted for editing is laid out appropriately, while taking into consideration an object that is not targeted for editing.

The present invention in its an aspect provides an editing apparatus comprising: a storage unit configured to store a plurality of templates in each of which a pattern used in laying out at least one object has been defined; a selection unit configured to select an object to be laid out; a setting unit configured to set a region used as a reference for laying out the object selected by the selection unit as a closed region within a predetermined region so as not to include an object that is not selected by the selection unit; a determination unit configured to enlarge the closed region until the closed region contacts on either an object that exists outside the closed region and that is not selected by the selection unit or an edge of the predetermined region, and determines the enlarged closed region as a layout region; a retrieval unit configured to retrieve a template into which the object selected by the selection unit can be laid out, from the plurality of templates stored in the storage unit; an embedding unit configured to embed the object selected by the selection unit into the template retrieved by the retrieval unit; and an insertion unit configured to insert the template, in which the object is embed by the embedding unit, into the determined layout region.

According to the present invention, it is possible to appropriately lay out an object targeted for editing while taking into consideration an object that is not targeted for editing.

Further features of the present invention will become apparent from the following description of exemplary embodiments with reference to the attached drawings.

### BRIEF DESCRIPTION OF THE DRAWINGS

FIG. 1 is a block diagram showing the configuration of an editing apparatus according to an embodiment of the present invention.

FIG. 2 is a diagram showing an example of a screen on which a page before being subjected to layout editing is displayed.

FIG. 3 is a flowchart showing an overall procedure of layout editing processing.

FIG. 4 is a diagram illustrating how objects targeted for layout editing are selected.

FIG. 5 is a flowchart showing a procedure of processing for determining a layout region and selecting a template.

FIG. 6 is a flowchart showing a detailed procedure of processing for determining a layout region.

FIG. 7 is a diagram showing a midpoint in the processing for determining a layout region.

FIG. 8 is a diagram illustrating a layout region having been determined.

FIG. 9 is a diagram showing an example of a table for referencing templates.

FIG. 10 is a diagram showing an example of the data structure of a template.

FIGS. 11A to 11D are diagrams showing templates.

FIG. 12 is a flowchart showing a procedure of layout editing processing.

FIG. 13 is a diagram showing a result obtained through the layout editing processing.

FIG. 14 is a diagram showing an example of the data structure of a page obtained through the layout editing processing.

FIG. 15 is a diagram showing another example of a page before being subjected to layout editing processing in a case where a circumscribed rectangular region overlaps an unselected object.

FIG. 16 is a diagram showing a result of the layout editing processing performed on the page shown in FIG. 15.

FIG. 17 is a diagram showing another example of a page before being subjected to layout editing processing in a case where a circumscribed rectangular region does not overlap an unselected object.

FIG. 18 is a diagram showing a result of the layout editing processing performed on the page shown in FIG. 17.

### DESCRIPTION OF THE EMBODIMENTS

Preferred embodiments of the present invention will now be described hereinafter in detail, with reference to the accompanying drawings. It is to be understood that the following embodiments are not intended to limit the claims of the present invention, and that not all of the combinations of the aspects that are described according to the following embodiments are necessarily required with respect to the means to solve the problems according to the present invention. Note that the same reference numerals have been given to constituent elements that are the same, and descriptions thereof will not be given.

The following is a description of a layout editing function for editing the layout of objects each having an attribute such as image or character and being included in one page of a printing medium, the layout editing function being one of the functions of an application (software) running on a PC, for example. A PC in which such an application is installed serves as an editing apparatus. Alternatively, a dedicated apparatus having a function corresponding to this application may be used as an editing apparatus. Examples of documents to be edited by the application include general documents and documents for specified use such as posters, postcards, and presentation data. The application has various functions in order to design a page of such a document, and examples of the functions include changing the sizes of constituent elements on a page, moving or rotating constituent elements, and editing text.

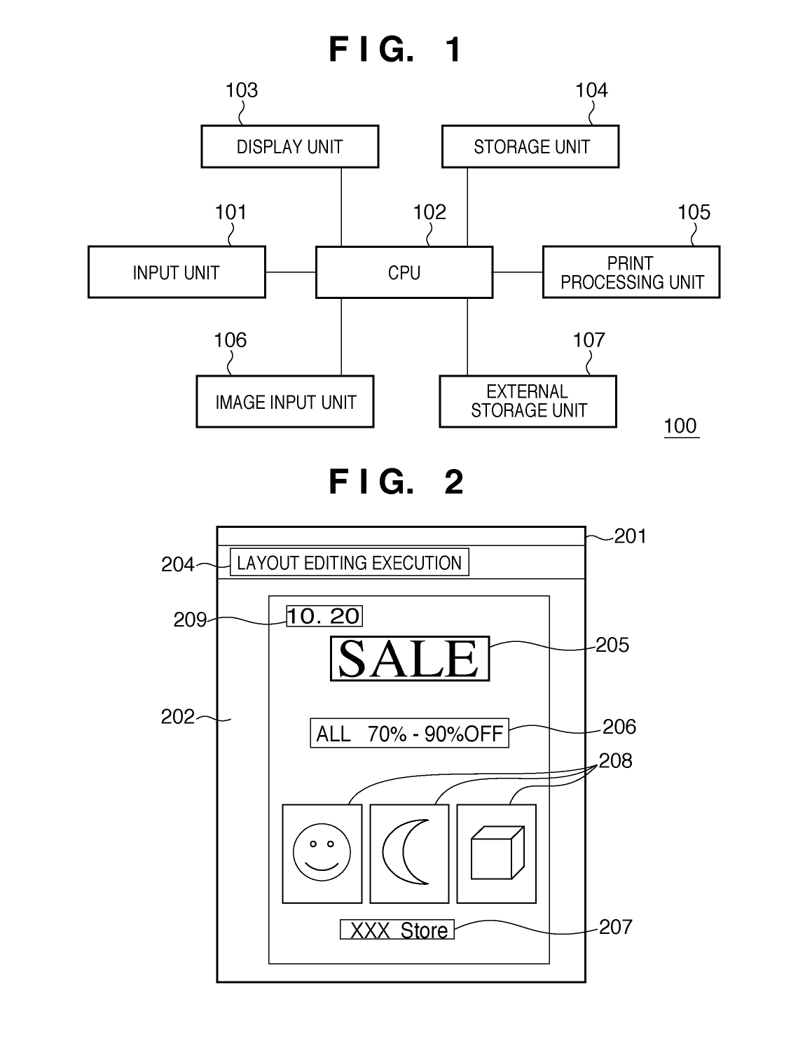

FIG. 1 is a block diagram showing the configuration of an editing apparatus 100 according to an embodiment of the present invention. An input unit 101 shown in FIG. 1 is, for example, a keyboard or a pointing device. A CPU 102 performs processing such as managing and controlling various blocks in the editing apparatus 100, inputting image data, and generating edit data for printing. The CPU 102 also executes processing shown in each flowchart discussed later. A display unit 103 is, for example, a display that displays a user interface or the like, and on the user interface screen, a user can select target objects in a document or check a document obtained by layout editing. A storage unit 104 is, for example, a hard disk that stores programs such as an application for performing layout editing according to the present embodiment, document data targeted for layout editing, templates, and so on. A print processing unit 105 performs print processing on document data that has undergone layout editing. An image input unit 106 is, for example, a film scanner, a flat-bed scanner, or a digital camera that receives input of document data or image data. An external storage unit 107 is, for example, a floppy disk (registered trademark).

FIG. 2 is a diagram showing an example of a screen on which one page of a document before being subjected to layout editing is displayed by the display unit 103. A screen 201 is a main screen of an application for performing layout editing according to the present embodiment. Although not shown, the screen 201 includes menus and toolbars that correspond to various types of processing, buttons, and a configuration for designing objects such as photographs or clipart. A preview region 202 displays one entire page of a document that is currently targeted for layout editing. Using the above-described toolbars or the like (not shown), a user can perform operations such as moving constituent elements (hereinafter referred to as “objects”) on the displayed page and changing the sizes of constituent elements. Such operations are performed through, for example, a keyboard or a pointing device. Although only one page of a document is shown in FIG. 2, a document including multiple pages may be targeted for layout editing. In that case, for example, the screen 201 may include a page turning command so that a user can display the desired page through that command. The screen 201 may further include an edit support function such as a guide, a grid, or a ruler. Using such an edit support function, a user can smoothly arrange objects in the desired positions. A button 204 is a layout editing execution button appearing on the toolbar of the screen 201. When the button 204 is pressed, layout editing processing described later is performed on the objects selected in the preview region 202. Note that the result obtained by execution of the layout editing processing is similarly displayed in the preview region 202. When no objects are selected in the preview region 202, the button 204 may be set to a non-pressable state.

As shown in FIG. 2, multiple objects 205, 206, 207, 208, and 209 are arranged on one page (hereinafter simply referred to as the “page”) of a document displayed in the preview region 202. Each object has an attribute, and the objects 205, 206, 207, and 209 have an attribute representing text data. The objects 208 have an attribute representing image data. In the present embodiment, objects having an attribute other than text and image, such as photograph, may be arranged on the page. Each object has its own region, and as shown in FIG. 2, the objects 206, 207, and 209 are displayed as dotted-line circumscribed rectangles. The objects 208 are also displayed similarly as dotted-line circumscribed rectangles, although in FIG. 2 they are displayed as solid-line square frames. Based on the regions of each object, layout editing can be performed such that the objects do not overlap one another. Among the objects 205 to 209, the object 205 is selected by the user. When an object is selected by, for example, the user clicking the pointing device or using the TAB key to operate the keyboard, the above-described circumscribed rectangle is displayed by the thick solid line as shown in FIG. 2. The user can select multiple objects on the page displayed in the preview region 202 by operating the SHIFT key on the keyboard while performing selection or dragging the pointing device.

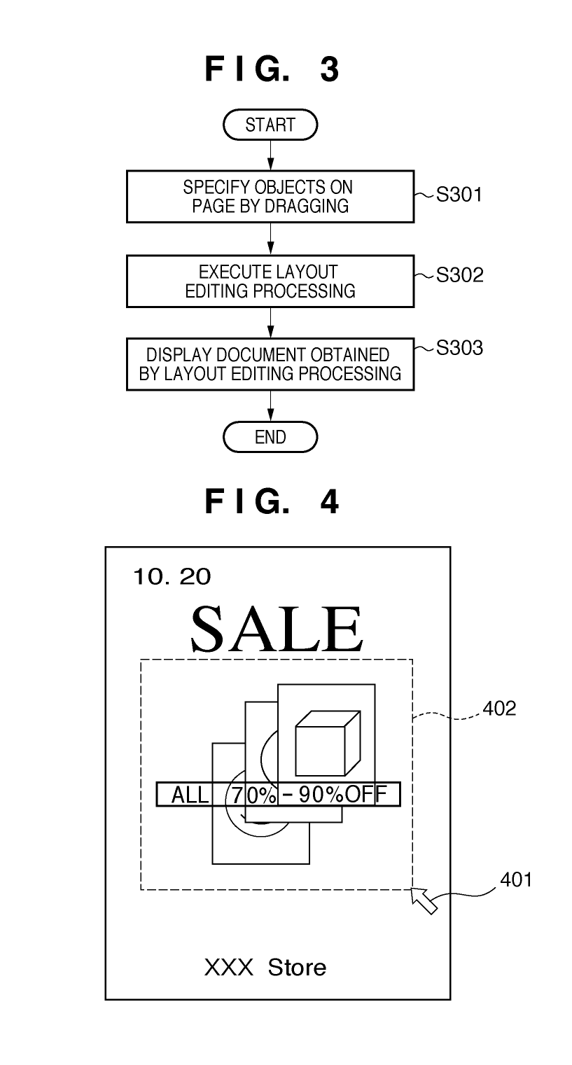

FIG. 3 is a flowchart showing an overall procedure of the layout editing processing according to the present embodiment. The flowchart of FIG. 3 shows a procedure of processing implemented by the CPU 102 executing a program such as an application stored in, for example, the storage unit 104 or the external storage unit 107. First, in step S301, the user selects multiple objects targeted for layout editing on the page displayed in the preview region 202 of the display unit 103 by, for example, dragging the pointing device. Next, when the user presses the button 204, layout editing processing is performed in step S302. The details of the layout editing processing will be discussed later. Then, in step S303, the page obtained by the layout editing processing is displayed in the preview region 202.

Next is a description of step S301 of FIG. 3 in which an object is selected by the user.

FIG. 4 is a diagram illustrating how objects targeted for layout editing processing are selected. As shown in FIG. 4, the user selects multiple objects by dragging a cursor 401 of, for example, the pointing device and thereby enclosing all the desired objects targeted for layout editing processing by the dotted line 402. In FIG. 4, the object 206 having the text attribute and the objects 208 having the image attribute shown in FIG. 2 are selected. Furthermore, in FIG. 4, the selected multiple objects shown in FIG. 2 are moved close to one another so that no unselected object exists between the selected objects. This is done in order to finalize a region used as a reference for determining a layout region described later. Suppose that the layout editing processing described later is performed with an unselected object remaining between selected objects. In that case, although the objects targeted for layout editing processing are arranged in accordance with the template, non-target objects are arranged irrespective of the arrangement of the target objects, and therefore an unbalanced layout is given as a result of the layout editing processing. In the case where, as shown in FIG. 2, no objects that are not targeted for layout editing exist between the objects 206 and 208 targeted for layout editing, the objects 206 and 208 may be selected without changing their arrangement of FIG. 2 by dragging. As described with reference to FIG. 2, when the objects 206 and 208 are selected, the circumscribed rectangles of the objects are displayed by the thick solid lines as shown in FIG. 4.

Next is a description of the layout editing processing performed in step S302 of FIG. 3.

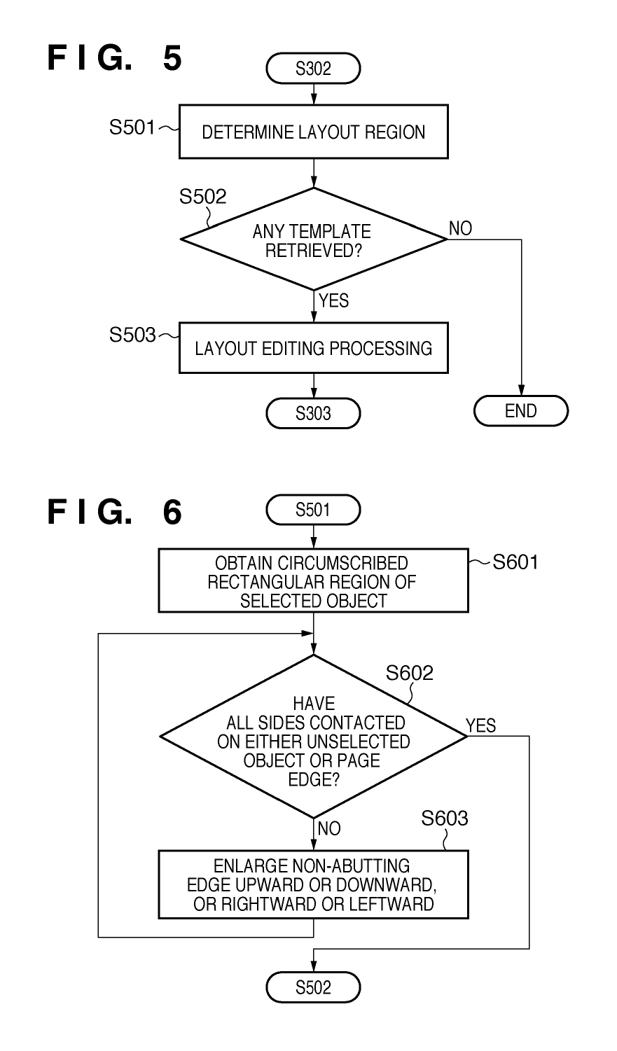

FIG. 5 is a flowchart showing a procedure of processing performed for determining a layout region and selecting a template during the layout editing processing. When the user has selected multiple objects in step S301, a layout region is determined based on the selected multiple objects in step S501.

FIG. 6 is a flowchart showing a detailed procedure of processing for determining a layout region performed in step S501 of FIG. 5. In step S601, the circumscribed rectangular regions of the multiple objects selected by the user are obtained. The “circumscribed rectangular regions” as used herein refer to rectangular regions circumscribing the objects 206 and 208 selected by the user, as shown in FIG. 4. Those circumscribed rectangular regions are used as a reference for determining a layout region. Instead of the rectangular regions circumscribing the objects 206 and 208, if the objects 206 and 208 are selected as a rectangular region proximate to the objects 206 and 208 as indicated by the dotted line 402 in FIG. 4, the selected region may be applied as-is as the circumscribed rectangular region in step S601.

Next, in step S602, it is determined whether or not the circumscribed rectangular region obtained in step S601 contacts on either an object that is not targeted for layout editing, i.e., an object that has not been selected in step S301 of FIG. 3, or an edge of the page displayed in the preview region 202. Here, the “edge” as used herein refers to an edge of a region in which objects can be arranged on the page targeted for editing. This determination is made for each side of each circumscribed rectangular region obtained in step S601. Referring to one side of a circumscribed rectangular region, if it has been determined that the side contacts on neither an object not selected in step S301 nor an edge of the page displayed in the preview region 202, the circumscribed rectangular region is progressively enlarged outward on that side (step S603). This enlargement processing continues to be performed until the one side contacts on either an object not selected in step S301 or an edge of the page displayed in the preview region 202. On the other hand, if it has been determined that the side contacts on either an object not selected in step S301 or an edge of the page displayed in the preview region 202, the enlargement processing is not performed on that side. Here, the enlargement processing may, for example, be a method for moving that one side outward by a predetermined number of pixels each time.

In step S602, if it has been determined that all of the four sides of the circumscribed rectangular region contact on either an object not selected in step S301 or an edge of the page displayed in the preview region 202, the procedure proceeds to step S502. In the determination of step S602, an edge of the page may be an edge of a printable region on that page. Through the processing as shown in FIG. 6, a layout region is determined.

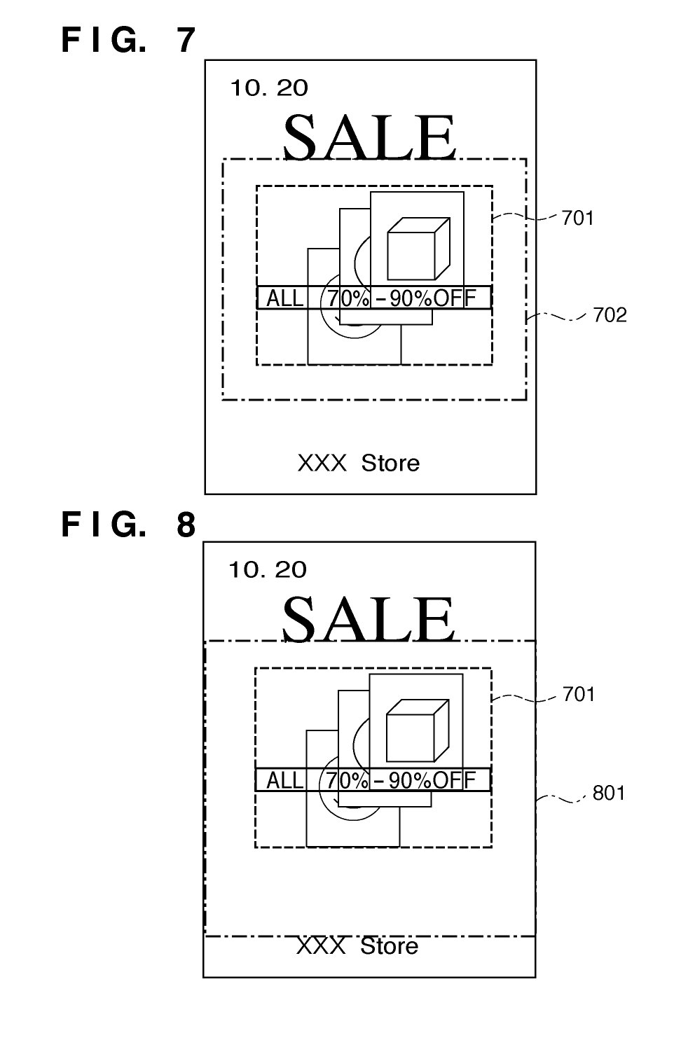

FIG. 7 is a diagram showing a midpoint in the processing for determining a layout region. A region 701 shown in FIG. 7 is a circumscribed rectangular region obtained in step S601. A region 702 is obtained at a midpoint in the processing for determining a layout region, between steps S602 and S603. Specifically, as shown in FIG. 7, the upper side of the region 702 contacts on the object “SALE” having the text attribute, and therefore the enlargement processing thereof has terminated. However, the other sides of the region 702 contact on neither an object not selected in step S301 nor an edge of the page displayed in the preview region 202, and therefore the enlargement processing thereof is still ongoing. A configuration is possible in which the state of FIG. 7 is not particularly shown in the user interface.

FIG. 8 is a diagram illustrating a layout region having been determined. A region 801 is the determined layout region. Specifically, the upper side of the region 801 contacts on the object “SALE” having the text attribute, and the lower side thereof contacts on the object “XXX Store” having the text attribute. The right and left sides of the region 801 contact on the edges of the page displayed in the preview region 202. Accordingly, the region 801 satisfies the condition specified in step S602 of FIG. 6 and is determined as a layout region.

Now refer back to FIG. 5. When the layout region has been determined in step S501, the procedure proceeds to step S502. In step S502, based on the attributes and the number of each type of objects selected in step S301, a template into which the selected objects can be laid out is retrieved from a template database that stores multiple templates in each of which a pattern used for layout has been defined in advance.

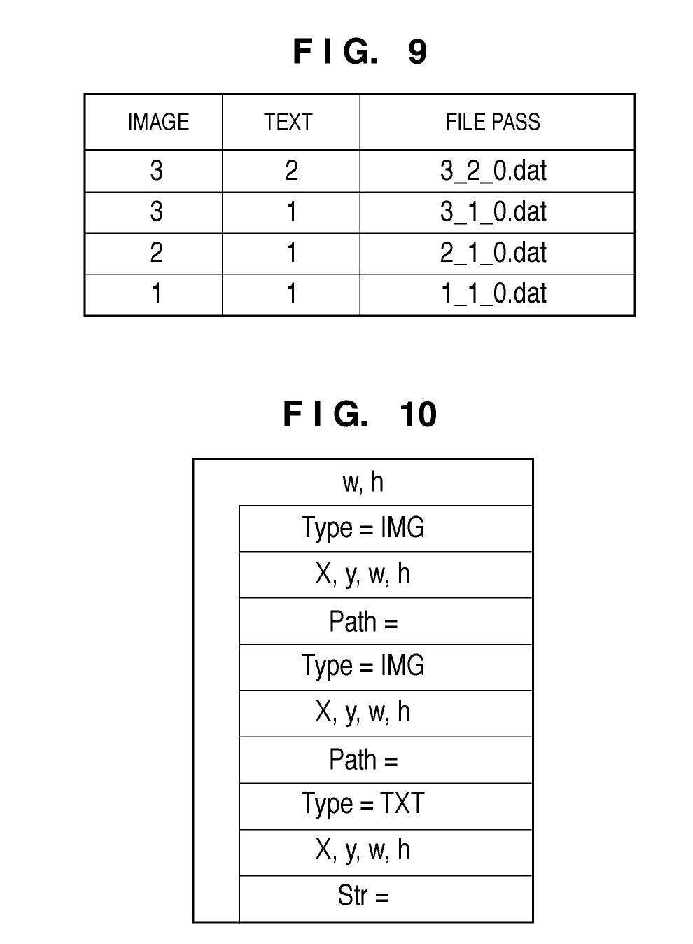

FIG. 9 is a diagram showing an example of a table used to acquire a template stored in the template database. As shown in FIG. 9, the table associates, for each template including objects, the number of objects having the image attribute in the template, the number of objects having the text attribute in the template, and a file path (a storage location including a filename) for referencing the template. For example, as shown in the top row of the table, a template including three objects having the image attribute and two objects having the text attribute has a file path (a filename in FIG. 9) of “3_{—}2_{—}0.dat”. In the present embodiment, the one object 206 having the text attribute and the three objects 208 having the image attribute have been selected. Accordingly, in step S502, a template “3_{—}1_{—}0.dat” is retrieved by referencing the table shown in FIG. 9. The table shown in FIG. 9 can be used to retrieve templates into which a maximum of three objects having the image attribute and one or two objects having the text attribute can be laid out. However, templates including a greater number of objects than the number shown in FIG. 9 may be specified by file paths, or items representing other types of attributes such as photograph or bar code may be provided in the table.

FIG. 10 is a diagram showing an example of the data structure of a template stored in the template database. Each template specified by the file paths stored in the table shown in FIG. 9 is constituted by elements, namely a total template size “w, h”, image parts “type=IMG”, and text parts “type=TXT”. FIG. 10 shows a template that includes elements for embedding two objects having the image attribute and one object having the text attribute. The image part element “type=IMG” and the text part element “type=TXT” each further include sub-elements such as coordinates “x, y, w, h” and a path “Path=”. The coordinates “x, y, w, h” represent a position in the template in which an object having the image attribute or an object having the text attribute is to be embedded. The path “Path=” represents a path to actual data to be embedded in that position. Although not shown in FIG. 10, predetermined default values are stored as the total template size “w, h” and the coordinates “x, y, w, h”.

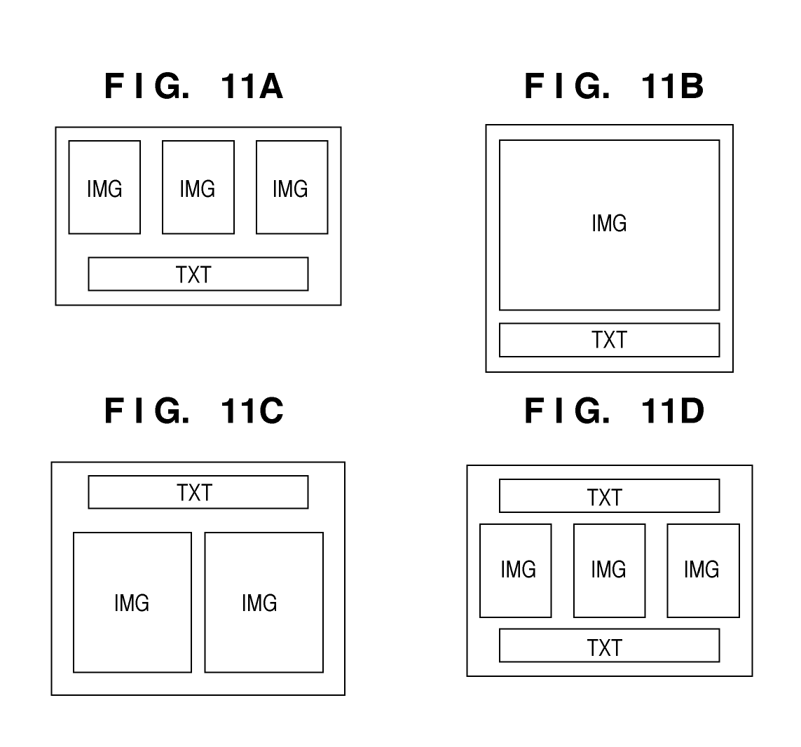

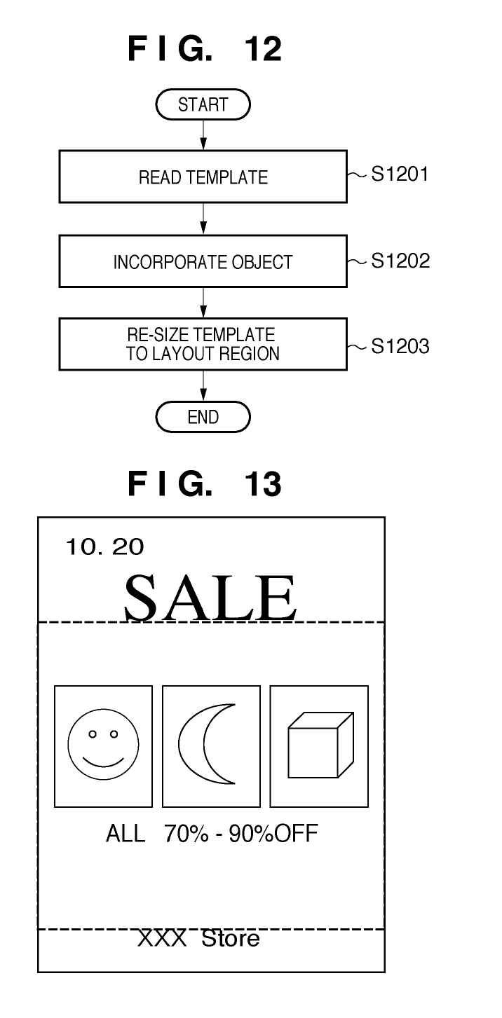

FIGS. 11A to 11D are diagrams showing templates represented by the data structure as shown in FIG. 10. For example, a template having the data structure shown in FIG. 10 is as shown in FIG. 11C. A predetermined default value is set as the total template size “w, h”, and the coordinates “x, y, w, h” are set such that each object is arranged in its relative position shown in FIG. 11C. The path “Path=” is a blank field until actual data to be embedded is determined.

In the present embodiment, since the template “3_{—}1_{—}0.dat” is retrieved in step S502, the template as shown in FIG. 11A is retrieved from the template database and selected. In step S502 of FIG. 5, if it has been determined that a template has been retrieved from the template database, the procedure proceeds to step S503. On the other hand, if it has been determined that no template has been retrieved, that is, if no template has been retrieved from the database shown in FIG. 9, a warning indicating that the layout editing processing cannot be performed is displayed on the display unit 103, and thereafter the layout editing processing ends. In step S503, the layout editing processing is performed based on the retrieved template, the selected multiple objects, and the determined layout region.

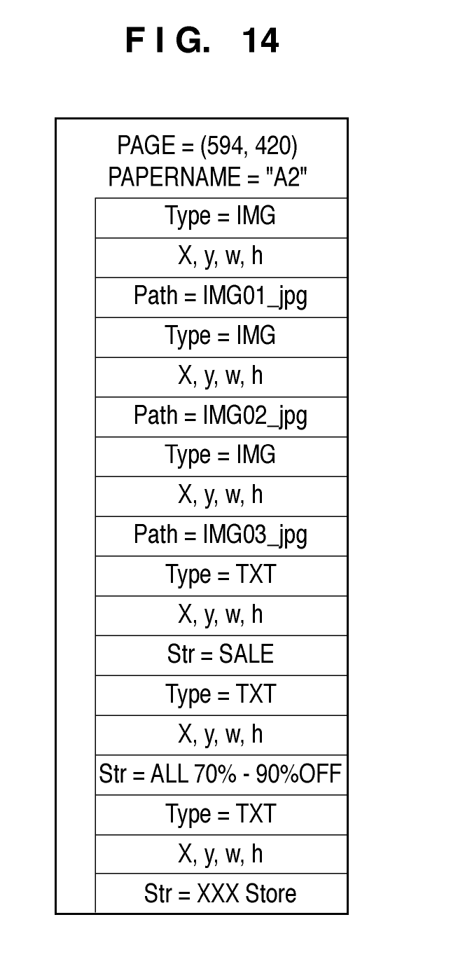

FIG. 12 is a flowchart showing a procedure of the layout editing processing. First, in step S1201, the template retrieved from the template database shown in FIG. 9 is read into a temporary storage region such as a RAM in the editing apparatus 100. In step S1202, the multiple objects selected in step S301 are embedded into the read template. Specifically, in the present embodiment, the object 206 having the text attribute and the objects 208 having the image attribute, which have been selected, are embedded into the template shown in FIG. 11A. The objects 206 and 208 each have a predetermined size, and the template has a default size. Accordingly, in the case of embedding the objects into the template, the sizes of the objects are enlarged or reduced as appropriate. Furthermore, in the case where the aspect ratio of an object is different from that of the element of the template into which the object is embedded, the object may be trimmed or may be arranged in the center of the element. Furthermore, for example, the font size of text may be changed in order to adjust the size of each object having the text attribute.

Next, in step S1203, the template into which the objects have been embedded is inserted into the layout region determined in step S501. Here, the insertion is made, for example, such that the template size is enlarged or reduced in accordance with the size of the layout region. In the case of enlarging or reducing the template size, if the template and the layout region have different aspect ratios, the template may be arranged in the center of the layout region in either the vertical or horizontal direction, for example. When the processing of step S1203 ends, the page obtained by the layout editing processing is displayed in the preview region 202 in step S303 of FIG. 3. FIG. 13 is a diagram showing the result of the layout editing processing according to the present embodiment.

It can be seen from a comparison between FIG. 2 and FIG. 13 that not only the positions of the object 206 and the objects 208 are interchanged, but also the objects 206 and 208 are arranged while being appropriately spaced from the other objects 205 and 207 not targeted for layout editing processing. In the present embodiment, as described above, the objects targeted for layout editing processing can be laid out appropriately and displayed for previewing while taking into consideration the layout balance with the other objects not targeted for layout editing processing. As a result, even a user who does not have enough design knowledge can easily perform appropriate layout editing.

FIG. 14 is a diagram showing an example of the data structure of a page that has undergone layout editing processing. The data structure shown in FIG. 14 is constituted by elements, namely a total page size “PAGE=(598,420)”, a page name “PAPERNAME=A2”, image parts “type=IMG”, and text parts “type=TXT”. Each of the image parts further includes sub-elements, namely a position “x, y, w, h” and a path “PATH=” storing a file path to actual data. Each of the text parts further includes sub-elements, namely a position “x, y, w, h” and a text storing region “STR=” storing a text content, alignment, a font size, a font name, and various decoration attributes. As shown in FIG. 14, image data is designated to reference data of IMG01.jpg, IMG02.jpg, and IMG03.jpg. This corresponds to actual data of the objects 208 having the image attribute. The text content is designated as “All 70%-90% OFF”. This corresponds to actual data of the object 206 having the text attribute. It can be seen from FIG. 14 that the total page size is 594 mm×420 mm and the page name is “A2”. The page that has undergone layout editing processing is stored in a storage area with the data structure as shown in FIG. 14 and can be used for, for example, print processing performed by the print processing unit 105.

The following is a description of the operation performed in the case where the circumscribed rectangular region obtained in step S601 of FIG. 6 overlaps another object.

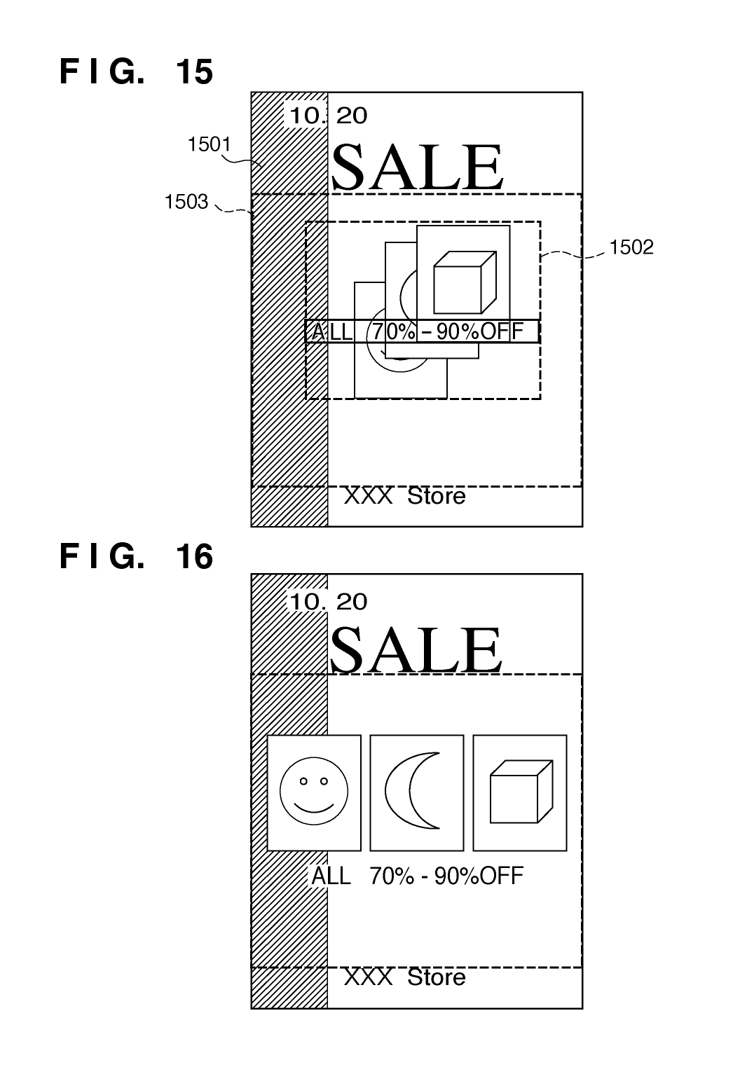

FIG. 15 is a diagram showing another example of a page before being subjected to layout editing. In FIG. 15, a vertically long graphic object 1501 exists on the left part of the page. A region 1502 is the circumscribed rectangular region obtained in step S601 of FIG. 6. In the present example, the circumscribed rectangular region 1502 overlaps the object 1501.

If the processing of steps S602 and S603 of FIG. 6 is performed according to the condition shown in FIG. 15, the processing of steps S602 and S603 is performed irrespective of the presence of the object 1501. Accordingly, a region 1503 is determined as the layout region. That is, the region 1503 is the same as the region 801 shown in FIG. 8. Furthermore, after a template is retrieved in step S502 and the layout editing processing is performed in step S503, the result as shown in FIG. 16 is obtained. This result of the layout editing processing performed on the objects 206 and 208 is the same as shown in FIG. 13.

Next is a description of the case where the circumscribed rectangular region 1502 does not overlap the object 1501.

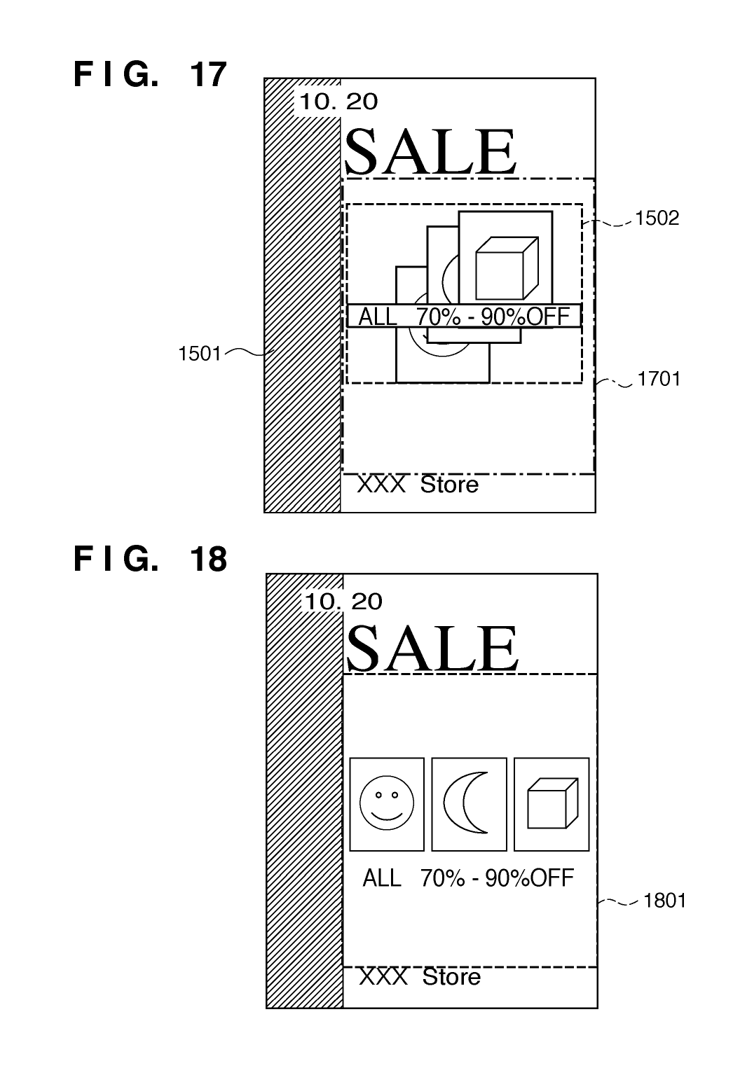

FIG. 17 is a diagram showing the case where the circumscribed rectangular region 1502 shown in FIG. 15 does not overlap the object 1501. If the processing of steps S602 and S603 of FIG. 6 is performed in the condition as shown in FIG. 17, the enlargement processing is performed until the left side of the circumscribed rectangular region 1502 contacts on, not the edge of the page, but the object 1501. Accordingly, a region 1701 is determined as the layout region. Furthermore, after a template is retrieved in step S502 and the layout editing processing is performed in step S503, the result as shown in FIG. 18 is obtained.

However, the result shown in FIG. 18 does not seem appropriate in terms of the fact that the character string “SALE” in the upper part of the page is centered on the page. Accordingly, in the present example, the layout is further modified from this condition such that the left side of a region 1801 is dragged through the pointing device so as to overlap the object 1501. Thereafter, the processing of steps S602 and S603 is performed again using the modified region as the circumscribed rectangular region. As a result, a layout editing result as shown in FIG. 16 can be obtained.

In the above-described embodiment, the layout region is determined by enlarging the outermost boundary, that is, the circumscribed rectangular region, of the selected multiple objects. Alternatively, in the present embodiment, a rectangular region used as a reference may be created by dragging in the desired region targeted for layout editing on the page displayed in the preview region 202. In that case, the layout region is determined by subjecting the rectangular region used as a reference to the enlargement processing of steps S602 and S603. As another alternative, the desired region targeted for layout editing may be designated by a point. In that case, the layout region may be determined by generating a predetermined square region around the designated point and performing the enlargement processing of steps S602 and S603 on that region. In this way, the layout region may be designated in a position separated from the positions of the selected multiple objects.

In the above examples, the layout region is a rectangular region, but it may be a region other than a rectangular region. Specifically, a closed region (including selected objects) that can come in various shapes including shapes other than rectangles may be determined in accordance with the user specification, and the closed region may be enlarged to a region that has a figure similar to the closed region and that does not include unselected objects. In the case where the closed region has an arbitrary shape, there is the possibility that a template of the same shape does not exist, but in that case, the layout of the selected objects may be determined by, for example, centering the objects within the enlarged region or allocating the objects in positions leaving an equal margin.

In the present embodiment, the layout region is determined as a region that contacts on either an unselected object or an edge of the page. However, for example in the case where image data constitutes a page, an edge may be detected within the image, and a region that contacts on the edge may be determined as the layout region by regarding the edge as the boundary of an object. Furthermore, in the present embodiment, a single template is retrieved, and the result of the layout editing processing performed only in accordance with the retrieved template is displayed in the preview region 202. However, in the case where multiple templates are retrieved based on the attributes and the number of each type of objects, the results of the layout editing processing performed in accordance with each of the multiple templates may be displayed collectively in the preview region 202.

### Other Embodiments

Aspects of the present invention can also be realized by a computer of a system or apparatus (or devices such as a CPU or MPU) that reads out and executes a program recorded on a memory device to perform the functions of the above-described embodiment, and by a method, the steps of which are performed by a computer of a system or apparatus by, for example, reading out and executing a program recorded on a memory device to perform the functions of the above-described embodiment. For this purpose, the program is provided to the computer for example via a network or from a recording medium of various types serving as the memory device (e.g., computer-readable medium).

Note that the description of the above example has taken the example of the case where the above-described processing is implemented by the CPU executing application programs. In this case, the number of CPUs is not limited to one, and multiple CPUs may execute processing in corporation with one another. Furthermore, the programs (or software) implemented by one or more CPUs can also be realized by supplying those programs to various devices via a network or various types of storage media. Part or all of the above-described processing may be executed by dedicated hardware such as an electric circuit.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2010-145524, filed Jun. 25, 2010, which is hereby incorporated by reference herein in its entirety.

What is claimed is:

1. An editing apparatus comprising:
a storage unit configured to store a plurality of templates in each of which a pattern used in laying out at least one object has been defined;
a selection unit configured to select an object to be laid out;
a setting unit configured to set a region used as a reference for laying out the object selected by the selection unit as a closed region within a predetermined region so as not to include an object that is not selected by the selection unit;
a determination unit configured to enlarge the closed region until the closed region contacts on either an object that exists outside the closed region and that is not selected by the selection unit or an edge of the predetermined region, and determines the enlarged closed region as a layout region;
a retrieval unit configured to retrieve a template into which the object selected by the selection unit can be laid out, from the plurality of templates stored in the storage unit;
an embedding unit configured to embed the object selected by the selection unit into the template retrieved by the retrieval unit; and
an insertion unit configured to insert the template, in which the object is embedded by the embedding unit, into the determined layout region.

2. The editing apparatus according to claim 1, further comprising:
a display unit configured to display, for previewing, the predetermined region in which the template has been inserted in the layout region by the insertion unit,
wherein, in a case where the layout region is modified after being displayed for previewing by the display unit, the determination unit determines a new layout region based on the modified layout region.

3. The editing apparatus according to claim 1, wherein an object in the predetermined region has an attribute representing either text data or image data.

4. The editing apparatus according to claim 3, further comprising:
a table that associates, for each of the plurality of templates, the number of objects having the attribute representing text data in the template, the number of objects having the attribute representing image data in the template, and a storage location of the template,
wherein the retrieval unit retrieves a corresponding template by referencing the table based on the number of objects selected by the selection unit and having the attribute representing text data and the number of objects selected by the selection unit and having the attribute representing image data.

5. The editing apparatus according to claim 1, wherein the closed region set by the setting unit is a closed region that circumscribes each object selected by the selection unit.

6. A layout editing method performed by an editing apparatus for performing layout editing on an object using a template, the method comprising:
a selection step of selecting an object to be laid out;
a setting step of setting a region used as a reference for laying out the object selected in the selection step as a closed region within a predetermined region so as not to include an object that is not selected in the selection step;
a determination step of enlarging the closed region until the closed region contacts on either an object that exists outside the closed region and that is not selected in the selection step or an edge of the predetermined region, and determining the enlarged closed region as a layout region;
a retrieval step of retrieving a template into which the object selected in the selection step can be laid out, from a plurality of templates stored in a memory that stores a plurality of templates in each of which a pattern used in laying out at least one object has been defined;
an embedding step of embedding the object selected in the selection step into the template retrieved in the retrieval step; and
an insertion step of inserting the template, in which the object is embedding in the embedding step, into the determined layout region.

7. A computer-readable storage medium storing a program that causes a computer to perform the functions of:
selecting an object to be laid out;
setting a region used as a reference for laying out the selected object as a closed region within a predetermined region so as not to include an object that is not selected;
enlarging the closed region until the closed region contacts on either an object that exists outside the closed region and that is not selected or an edge of the predetermined region;
determining the enlarged closed region as a layout region;
retrieving a template into which the selected object can be laid out, from a plurality of templates stored in a memory;
embedding the selected object into the retrieved template; and
inserting the template, in which the object is embedded, into the determined layout region.
